(19) United States
(12) Patent Application Publication
(10) Pub. No.: US 2024/0320365 A1
(43) Pub. Date: Sep. 26, 2024

(54) DATA PROTECTION DEVICE AND DATA PROTECTION METHOD

(71) Applicant: SigmaStar Technology Ltd., Xiamen (CN)

(72) Inventors: Qin-Wei She, Xiamen (CN); Yan-Xiong Wu, Xiamen (CN); Xiao-Min Zhang, Xiamen (CN)

(21) Appl. No.: 18/395,990

(22) Filed: Dec. 26, 2023

(30) Foreign Application Priority Data
Mar. 21, 2023 (CN) 202310276908.4

(51) Int. Cl. G06F 21/62; H04L 9/40

(52) U.S. Cl. CPC G06F 21/6245; H04L 63/0435

(57) ABSTRACT

A data protection device includes a memory, a read-only memory and a verification circuit. The read-only memory stores first confidential data, and transmits the first confidential data to the memory after being powered up, wherein the first confidential data includes multiple groups of repetitive data and the groups of repetitive data are the same with one another. The verification data determines whether the first confidential data is valid before a processor reads the first confidential data from the memory, and allows the processor to read the first confidential data from the memory when the first confidential data is valid.

This application claims the benefit of China application Serial No. CN202310276908.4, filed on Mar. 21, 2023, the subject matter of which is incorporated herein by reference.

### BACKGROUND OF THE INVENTION

### Field of the Invention

The present application relates to a data protection device, and more particularly to a data protection device that ensures data security by using repetitive data and a simple logic operation, and a data protection method thereof.

### Description of the Related Art

In some applications, an electronic device may store confidential data demanding high security requirements. If the confidential data is illegally attacked or altered (for example, by fault injection techniques such as changing frequency, voltage values, and original data values), errors may occur in system operations or data leakage or tampering may be resulted. For example, in some current techniques, an electronic device uses a one-time programmable memory to store such type of confidential data. However, if an operation state of the one-time programmable memory is changed due to the illegal alteration, it remains possible that the confidential data stored in the one-time programmable memory be tempered with, leading to degraded system security.

### SUMMARY OF THE INVENTION

In some embodiments, it is an object of the present application to provide a data protection device and a data protection method so as to improve the drawbacks of the prior art.

In some embodiments, a data protection device includes a memory, a read-only memory and a verification circuit. The read-only memory stores first confidential data, and transmits the first confidential data to the memory after being powered up, wherein the first confidential data includes multiple groups of repetitive data and the groups of repetitive data are the same with one another. The verification circuit determines whether the first confidential data is valid before a processor reads the first confidential data from the memory, and allows the processor to read the first confidential data from the memory when the first confidential data is valid.

In some embodiments, a data protection method applied to a data protection device includes operations of: transmitting first confidential data to a memory after the data protection device is powered up, wherein the first confidential data includes multiple groups of repetitive data and the groups of repetitive data are the same with one another; determining whether the first confidential data is valid according to the groups of repetitive data in the first confidential data before a processor reads the first confidential data from the memory; and allowing the processor to read the first confidential data when the first confidential data is valid.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of an electronic system according to some embodiments of the present application;

FIG. 2 is a flowchart of multiple operations performed by the data protection device in FIG. 1 according to an embodiment of the present application;

FIG. 3 is a flowchart of operations performed according to corresponding confidential data by the verification circuit in FIG. 1 according to an embodiment of the present application; and

FIG. 4 is a flowchart of a data protection method according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

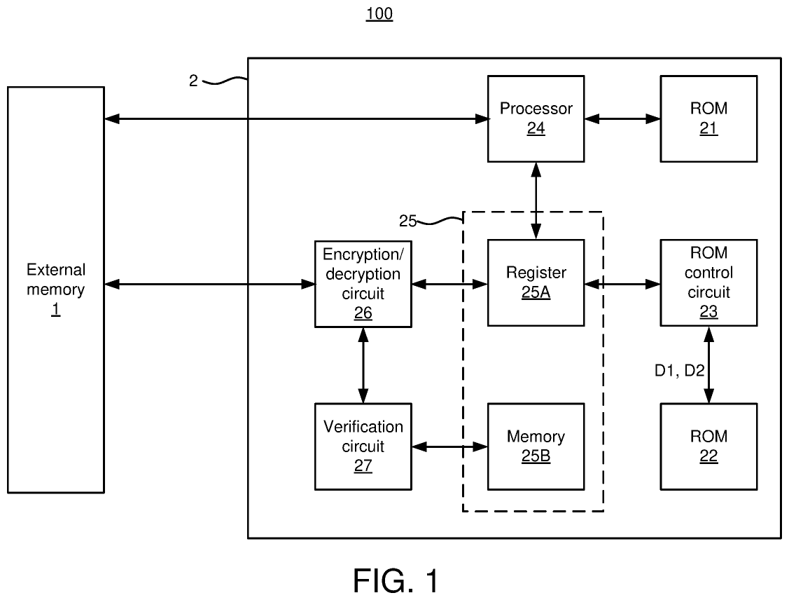

FIG. 1 shows a schematic diagram of an electronic system 100 according to some embodiments of the present application. The electronic system 100 includes an external memory 1 and a data protection device 2. The external memory 1 may operate in collaboration with the data protection device 2; for example, the data protection device 2 may store operated data to the external memory 1, or the external memory 1 may provide data needed by the data protection device 2. In some embodiments, the external memory 1 may be, for example but not limited to, a dynamic random access memory (DRAM).

The data protection device 2 includes a read-only memory (ROM) 21, a read-only memory 22, a ROM control circuit 23, a processor 24, a storage circuit 25, an encryption/decryption circuit 26 and a verification circuit 27. In some embodiments, the read-only memory 21 can store software or program codes demanding high security requirements, wherein the software or program codes are configured to be allowed to be used by the processor 24 after being decrypted. In some embodiments, the read-only memory 22 is a one-time programmable (OTP) memory, and can store multiple pieces of confidential data D1 (or at least one piece of confidential data D1) and multiple pieces of confidential data D2 (or at least one piece of confidential data D2), wherein security requirements of the confidential data D2 are lower than security requirements of the confidential data D1. For example, the table below lists configuration details of the confidential data D1 and the confidential data D2:

| Definition of | | Data size (number | Automatically |
|---|---|---|---|
| data | Function | of bits) | loaded? |
| D1 | Key | 128*8 | Yes |
| D1 | Password of | 32*8 | Yes |
| | debugging tools | | |
| D1 | Enable safe boot | 1*8 | Yes |
| D2 | Boot storage area | 3 | Allow all |
| D2 | Bus mode of flash | 2 | Allow all |
| | memory | | |

In the table above, each of the pieces of confidential data D1 includes multiple groups of repetitive data, which may be generated by bit expansion or data copy operations. For example, the confidential data D1 corresponding to the function “key” includes 8 groups of repetitive data, wherein the number of bits of each group of repetitive data is 128, and the 8 groups of repetitive data are the same with one another. For example, if original data of the confidential data D1 above is 101110 . . . 1, (a total of 128 bits), bit expansion may be performed on all bits of the original data or the original data may be directly copied to generate 8 groups of the same repetitive data (that is, each group of repetitive data is 10110 . . . 1 (a total of 128 bits)). Similarly, how each piece of confidential data D1 is generated can be understood accordingly.

In the table above, functions corresponding to the multiple pieces of confidential data D1 are directly associated with security of the overall system; for example, the functions of the confidential data D1 may include a key used for encryption/decryption, a verification password needed by debugging tools and data used to enable safe boot. In contrast, functions corresponding to the multiple pieces of confidential data D2 demanding lower security requirements; for example, the functions of the confidential data D2 may include setting a boot storage area and setting a bus mode of a flash memory. To enhance security of the multiple pieces of confidential data D1, after the memory 22 is powered up and before the processor 24 starts to operate, the ROM control circuit 23 may automatically load the confidential data D1 to a memory 25B in the storage circuit 25, so as to provide the confidential data D1 to the verification circuit 27 for verification. According to different requirements, after the memory 22 is powered up and before the processor 24 starts to operate, the ROM control circuit 23 may also automatically load the confidential data D2 to the memory 25B.

The storage circuit 25 includes a register 25A and the memory 25B above. The memory 25B may be, for example but not limited to, a static random access memory (SRAM), which may store the multiple pieces of confidential data D1 and/or confidential data D2 transmitted from the read-only memory 22. In some embodiments, when the processor 24 and/or the encryption/decryption circuit 26 is to read a piece of corresponding data among the multiple pieces of confidential data D1 from the memory 25B, the verification circuit 27 may verify whether the corresponding data is valid. For example, the verification data 27 may determine, according to all of the repetitive data in the corresponding data, whether the corresponding data has been tampered with (for example, by an external attack). If the verification circuit 27 determines that the corresponding data has not been tampered with, the verification circuit 27 may determine that the corresponding data is valid. In this case, the verification circuit 27 may set related parameters and/or states in the register 25A for the encryption/decryption circuit 26 to learn that the corresponding data is valid and be allowed to read the corresponding data from the memory 25B. Or, if the corresponding data is invalid, the verification circuit 27 may issue an interrupt request to the processor 24 and/or the encryption/decryption circuit 26, so as to control the processor 24 and/or the encryption/decryption circuit 26 to stop original operations, thereby preventing the system from using the corresponding confidential data D1 that may have been tampered with. In other words, each time the corresponding confidential data D1 in the memory 25B is to be used, the verification data 27 may determine whether the corresponding confidential data D1 has been tampered with so as to enhance system security.

More specifically, the encryption/decryption circuit 26 can use the corresponding confidential data D1 (corresponding to the key in the table above) in the memory 25B to perform encryption/decryption. Before the encryption/decryption circuit 26 reads the corresponding confidential data D1 from the memory 25B, the verification circuit 27 may determine, according to the 8 groups of repetitive data in the corresponding confidential data D1, whether the corresponding confidential data D1 is valid. If the verification circuit 27 determines that the corresponding confidential data D1 is valid, the encryption/decryption circuit 26 may read the corresponding confidential data D1 from the memory 25B and perform decryption according to the corresponding confidential data D1 to generate a decryption result (for example, another key) and store the decryption result to the register 25A or the external memory 1. Thus, the processor 24 can use the decryption result to verify whether software or program codes read from the read-only memory 21 is legal (for example, using the decryption result to decrypt the software or program codes) In some embodiments, the encryption/decryption circuit 26 may be, for example but not limited to, a processing circuit that executes an advanced encryption standard (AES) algorithm.

In some embodiments, since the multiple pieces of confidential data D2 demanding lower security requirements, the confidential data D2 does not undergo bit expansion or data copy processes. That is, different from the multiple pieces of confidential data D1, neither of the multiple pieces of confidential data D2 includes multiple sets of repetitive data. Correspondingly, the verification circuit 27 may also be configured not to determine whether the confidential data D2 is valid. With the configuration above, the data size of the confidential data D2 can be made to be less than the data size of the confidential data D1, thereby reducing the storage spaces needed by the read-only memory 22 and the memory 25B. In some embodiments, the table above may further record storage address information of each of the multiple pieces of confidential data D1 and/or confidential data D2 in the read-only memory 22, and use a state value to indicate whether the corresponding confidential data D1 or confidential data D2 is to be automatically loaded to the memory 25B after the read-only memory 22 is powered up. In some embodiments, the memory 25B may store the table and state value above, and determine, according to the table and state value above, whether data having been read belongs to the confidential data D1 that needs to be verified or the confidential data D2 that does not need to be verified.

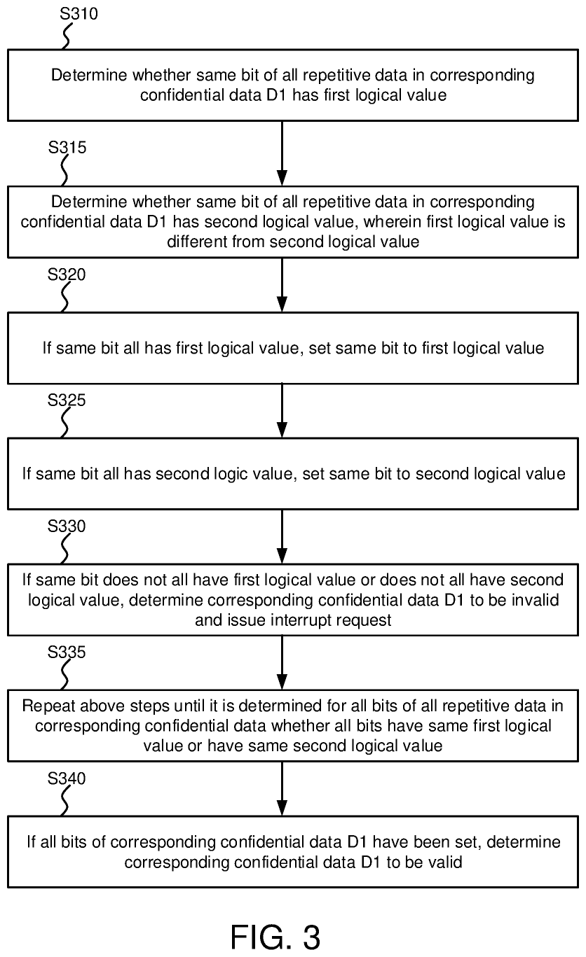

As described above, when the read-only memory 22 is powered up (and before the processor 24 starts to operate), the read-only memory 22 automatically transmits the multiple pieces of confidential data D1 to the memory 25B. In some embodiments, before the read-only memory 22 transmits the multiple pieces of confidential data D1 to the memory 25B, the verification circuit 27 may determine whether each piece of the confidential data D1 is valid. If any piece of confidential data D1 is invalid, the verification circuit 27 may issue an interrupt to the processor 24, so as to prevent the system from continuing using the confidential D1 that may have been tampered with. Thus, it can be determined whether the confidential data D1 originally stored in the read-only memory 22 has been tampered with, thereby enhancing overall security. Related operation details of the verification circuit 27 are to be described with reference to FIG. 3 below.

It should be noted that the above configuration details of the electronic system 100 in FIG. 1 are merely examples, and the present application is not limited to these examples. Various electronic systems suitable for a data verification mechanism of the data protection device 2 are to be encompassed with the scope of the present application. Moreover, the data types of the multiple pieces of confidential data D1 and D2 are merely examples, and the present application is similarly not limited to these examples. According to actual requirements, data to be used may be selectively set as the confidential data D1 demanding higher security requirements or the confidential data D2 demanding lower security requirements. Similarly, in the table above, the number of repetitive data is merely an example. According to actual security requirements, the number of repetitive data may be correspondingly adjusted. For example, the number of repetitive data may be increased for higher security requirements, or the number of repetitive data may be reduced for lower security requirements.

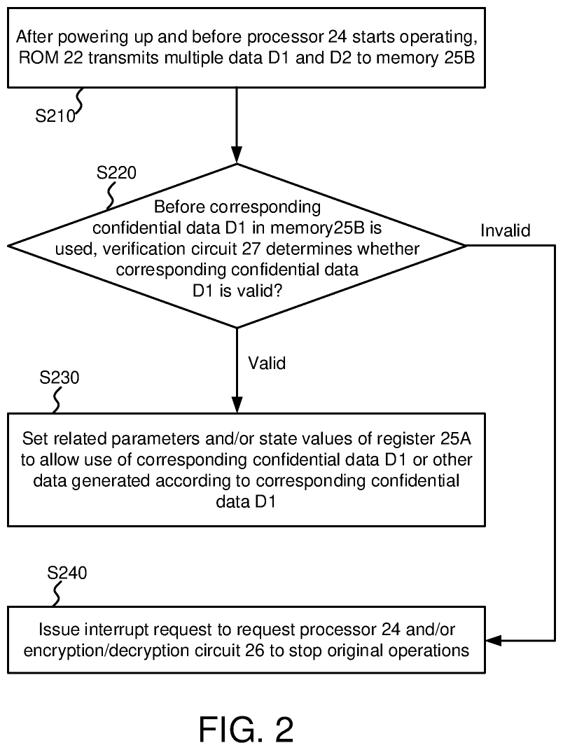

FIG. 2 shows a flowchart of multiple operations performed by the data protection device 2 in FIG. 1 according to an embodiment of the present application. In operation S210, after being powered up and before the processor 24 starts to operate, the read-only memory 22 transmits multiple pieces of confidential data D1 and D2 to the memory 25B. As described above, after the read-only memory 22 is powered up and before the processor 24 starts to operate, the read-only memory 22 may transmit the multiple pieces of confidential data D1 and D2 to the memory 25B.

With the configuration above, before the processor 24 starts to operate, the memory 25B may receive the confidential data D1 and D2 from the read-only memory 22. Thus, the processor 24 is prevented from being controlled by a third party (for example, a hacker) and thus the multiple pieces of confidential data D1 and D2 transmitted from the read-only memory 22 are prevented from being tampered with. Moreover, as described above, the processor 24 is allowed to access the memory 25B only with permission of the verification circuit 27 (by setting related parameters or state values in the register 25A). Thus, the processor 24 is prevented from being controlled by a third party and thus the multiple pieces of confidential data D1 and D2 stored in the memory 25B are prevented from being tampered with. Moreover, as described above, in some embodiments, before the read-only memory 22 transmits the confidential data D1 to the memory 25B, the verification circuit 27 may also determine whether the confidential data D1 is valid, and allow the memory 25B to store the confidential data D1 before the confidential data D1 is determined as being valid.

In operation S220, before using the corresponding confidential data D1 stored in the memory 25B, the verification circuit 27 determines whether the corresponding confidential data D1 is valid. Operation S230 is performed if the corresponding confidential data D1 is valid. Operation S240 is performed if the corresponding confidential data D1 is invalid. In operation S230, related parameters and/or state values of the register 25A are set, so as to allow the use of the corresponding confidential data D1 or other data generated according to the corresponding confidential data D1. In operation S240, the verification circuit 27 issues an interrupt request to request the processor 24 and/or the encryption/decryption circuit 26 to stop original operations.

For example, as described above, before the encryption/decryption circuit 26 (and/or the processor 24) uses the confidential data D1 serving a function as a key, the verification circuit 27 may determine whether the corresponding confidential data D1 is valid (operation S220). If the verification circuit 27 determines that the corresponding confidential data D1 is valid, the encryption/decryption circuit 26 may perform an operation on the corresponding confidential data D1 and set related parameters and/or state values of the register 25A, so as to allow the processor 24 to use a decryption result generated according to the corresponding confidential data D1 (operation S230). On the other hand, if the verification circuit 27 determines that the corresponding confidential data D1 is invalid, the verification circuit 27 may issue an interrupt request to the processor 24 and/or the encryption/decryption circuit 26, such that the processor 24 and/or the encryption/decryption circuit 26 suspends the original operations or directly exit a currently executed program, thereby preventing the processor 24 and/or the encryption/decryption circuit 26 from continuing using the confidential data D1 that may have been tampered with (operation 240). Thus, subsequent system operation security is ensured.

FIG. 3 shows a flowchart of multiple operations performed according to corresponding the confidential data D1 by the verification circuit 27 in FIG. 1 according to an embodiment of the present application. In operation S310, it is determined whether a same bit of each of all repetitive data in the corresponding confidential data D1 has a first logical value. In operation S315, it is determined whether the same bit of each of all the repetitive data in the corresponding confidential data D1 has a second logical value, wherein the first logical value is different from the second logical value. In operation S320, if the same bit in each of the repetitive data all has the first logical value, the same bit is set to the first logical value. In operation S325, if the same bit in each of the repetitive data all has the second logical value, the same bit is set to the second logical value. In operation S330, if the same bit does not all have the first logical value or does not all have the second logical value, it is determined that the corresponding confidential data D1 is invalid, and an interrupt request is issued. In operation S335, the steps above are repeated, until it is determined for all of the bits of all the repetitive data in the corresponding confidential data D1. In operation S340, if all of the bits of the corresponding confidential data D1 have been set, it is determined that the corresponding confidential data D1 is valid.

More specifically, taking the confidential data D1 serving the function as a key for example, each of the 8 groups of repetitive data in the confidential data D1 is 128-bit. Thus, the verification circuit 27 may first perform a logic operation (for example, an AND or NAND operation) on the 1^{st} bit of each of the 8 groups of repetitive data to determine whether the 1^{st} bit of each of the 8 groups of repetitive data all has a first logical value (for example, logic 1). For example, the verification circuit 27 may include an AND gate circuit, which is capable of determining whether the 1^{st} bit of each of the 8 groups of repetitive data is logic 1 (operation S310). If the 1^{st} bit of each of the 8 groups of repetitive data is logic 1, the AND gate circuit generates an output signal in logic 1. Conversely, if any of the 1^{st} bit of each of the 8 groups of repetitive data is not logic 1, the AND gate circuit generates an output signal in logic 0.

Next, the verification circuit 27 may first perform a logic operation (for example, an OR or NOR operation) on the 1^{st} bit of each of the 8 groups of repetitive data to determine whether the 1^{st} bit of each of the 8 groups of repetitive data all has a second logical value (for example, logic 0). For example, the verification circuit 27 may include an OR gate circuit, which is capable of determining whether the 1^{st} bit of each of the 8 groups of repetitive data is logic 0 (operation S315). If the 1^{st} bit of each of the 8 groups of repetitive data is logic 0, the OR gate circuit generates an output signal in logic 0. Conversely, if any of the 1^{st} bit of each of the 8 groups of repetitive data is not logic 0, the OR gate circuit generates an output signal in logic 1.

If the 1^{st} bit of each of the 8 groups of repetitive data is logic 1, the verification circuit 27 may set the first bit of the corresponding confidential data D1 to logic 1 (operation S320). If the 1^{st} bit of each of the 8 groups of repetitive data is logic 0, the verification circuit 27 may set the first bit of the corresponding confidential data D1 to logic 0 (operation S325). Alternatively, if the 1^{st} bit of each of the 8 groups of repetitive data is not all logic 1 or not all logic 0, it means that the 1^{st} bit of at least one of the 8 groups of repetitive data may have been tampered with. In this case, the verification circuit 27 may output an interrupt request so as to control the processor 24 and/or the encryption/decryption circuit 26 to stop the original operations (operation S330). Similarly, the verification circuit 27 may sequentially verify the 2^{nd} bit, the 3^{rd} bit . . . the 127^{th} bit and the 128^{th} bit of each of the 8 groups of repetitive data, so as to set all of the bits of the corresponding confidential data (operation S335). If all of the bits of the corresponding confidential data D1 have been set, it is determined that the corresponding confidential data D1 is valid (operation S340).

With the configuration above, the verification circuit 27 can use a simple logic circuit (for example, the AND gate circuit and the OR gate circuit, or the NAND gate circuit and NOR gate circuit above) to verify whether the same bit in these groups of repetitive data has been tampered with. When the same bit in all of the repetitive data has the same logical value, the verification circuit 27 sets the same bit to the same logical value. Once all bits of all the repetitive data have passed the verification and have been set, the verification circuit 27 may determine that the corresponding confidential data D1 is valid (that is, determined as not having been tampered with). Thus, security of the multiple pieces of confidential data D1 stored in the memory 25B is ensure at all times. Moreover, compared to a more complicated verification mechanism that employs a checksum, the verification circuit 27 may use a simpler logic operation to verify the validity of the confidential data D1 so as to save more processing time.

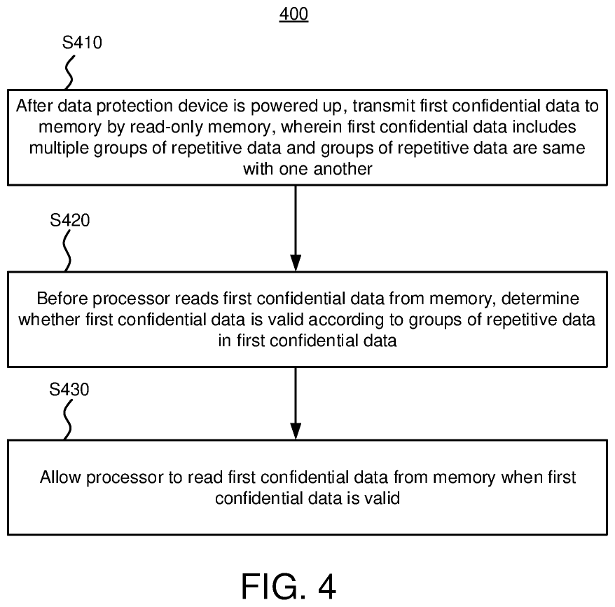

FIG. 4 shows a flowchart of a data protection method 400 according to some embodiments of the present application, wherein the data protection method 400 is applicable to a data protection device. In operation S410, after the data protection device is powered up, first confidential data is transmitted to a memory by a read-only memory, wherein each piece of the first confidential data includes multiple groups of repetitive data, and these groups of repetitive data are the same with one another. In operation S420, before the processor reads the first confidential data from the memory, it is determined whether the first confidential data is valid according to the groups of repetitive data in the first confidential data. In operation S430, the processor is allowed to obtain the first confidential data from the memory when the first confidential data is valid.

The details of the multiple operations above may be referred from the description associated with the foregoing embodiments, and are omitted herein for brevity. The plurality operations of the data protection method 400 above are merely examples, and are not limited to being performed in the order specified in these examples. Without departing from the operation means and ranges of the various embodiments of the present application, additions, replacements, substitutions or omissions may be made to the operations of the data protection method 400, or the operations may be performed in different orders (for example, simultaneously performed or partially simultaneously performed).

In conclusion, the data protection device and the data protection method according to some embodiments of the present application can use a simple logic operation to efficiently verify whether confidential data has been tampered with before the confidential data is used. Thus, security of the confidential data is ensure at all times to thereby enhance overall system security.

While the present application has been described by way of example and in terms of the preferred embodiments, it is to be understood that the disclosure is not limited thereto. Various modifications made be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. A data protection device, comprising:
a memory;
a read-only memory, storing first confidential data, and transmitting the first confidential data to the memory after being powered up, wherein the first confidential data comprises a plurality of groups of repetitive data and the groups of repetitive data are the same with one another; and
a verification circuit, determining whether the first confidential data is valid before a processor reads the first confidential data from the memory, and allowing the processor to read the first confidential data from the memory when the first confidential data is valid.

2. The data protection device according to claim 1, wherein the verification circuit determines whether a same bit in each of the groups of repetitive data all has a same logical value to determine whether the first confidential data is valid.

3. The data protection device according to claim 1, wherein the verification circuit determines whether a same bit in each of the groups of repetitive data all has a first logical value and determines whether the same bit in each of the groups of repetitive data all has a second logical value to determine whether the first confidential data is valid, wherein the first logical value is different from the second logical value.

4. The data protection device according to claim 3, wherein when the same bit in the groups of repetitive data all has the first logical value, the verification circuit sets the same bit to the first logical value.

5. The data protection device according to claim 3, wherein when the same bit does not all have the first logical value or does not all have the second logical value, the verification circuit determines the first confidential data to be invalid, and issues an interrupt request to the processor.

6. The data protection device according to claim 1, wherein the read-only memory further stores second confidential data, the second confidential data does not comprise a plurality of groups of second repetitive data, and the verification circuit does not verify whether the second confidential data is valid.

7. The data protection device according to claim 6, wherein a data size of the second confidential data is less than a data size of the first confidential data.

8. The data protection device according to claim 1, wherein the verification circuit further verifies whether the first confidential data is valid before the read-only memory transmits the first confidential data to the memory.

9. The data protection device according to claim 1, wherein the first confidential data comprises a key used for encryption/decryption.

10. The data protection device according to claim 1, wherein the read-only memory transmits the first confidential data to the memory before the processor starts to operate.

11. A data protection method applied to a data protection device, the data protection method comprising:
after the data protection device is powered up, transmitting first confidential data to a memory by a read-only memory, wherein the first confidential data comprises a plurality of groups of repetitive data and the groups of repetitive data are same with one another;
before a processor reads the first confidential data from the memory, determining whether the first confidential data is valid according to the groups of repetitive data in the first confidential data; and
allowing the processor to obtain the first confidential data from the memory when the first confidential data is valid.
